(19) United States
(12) Patent Application Publication
(10) Pub. No.: US 2019/0300447 A1
(43) Pub. Date: Oct. 3, 2019

(54) High-temperature Resistant Lightweight Thermal Insulation Material with Dual-pore Structure and Preparation Method Thereof

(71) Applicant: PROENERGY KILN MATERIAL TECHNOLOGY CO. LTD.

(72) Inventors: Lucun GUO, Nanjing, Jiangsu (CN); Longxing GENG, Nanjing, Jiangsu (CN); Han CHEN, Nanjing, Jiangsu (CN)

(21) Appl. No.: 16/315,817

(22) PCT Filed: Jul. 5, 2017
(86) PCT No.: PCT/CN2017/091868

§ 371 Date: Jan. 7, 2019

(30) Foreign Application Priority Data
Jul. 8, 2016 (CN) 201610538298.0

(51) Int. Cl. C04B 38/00; C04B 38/06; C04B 35/10; C04B 35/64; C04B 35/634; C04B 35/636; B28B 3/20; B28B 11/24

(52) U.S. Cl. CPC C04B 38/0009; B28B 2003/203; C04B 38/068; C04B 35/10; C04B 35/64; C04B 35/63416; C04B 35/6365; B28B 3/20; B28B 11/243; C04B 2235/3217; C04B 2235/3418; C04B 2235/3463; C04B 2235/349; C04B 2235/6021; C04B 2235/6562; C04B 2235/9607; C04B 38/0054

(57) ABSTRACT

A high-temperature resistant lightweight thermal insulation material having a dual-pore structure and a preparation method thereof, wherein the material is prepared by adding a molding promoter and a pore former into raw materials including alumina, silica and aluminosilicate powders, stirring the resulting mixture evenly and extrusion molding the same, followed by sintering, whereby the high-temperature resistant lightweight thermal insulation material having a dual-pore structure comprising macroscopic through-pores and micro-pores is obtained, and wherein the ratio of the total volume of the through-pores to the total volume of the micro-pores is 0.5 to 25:1.

### TECHNICAL FIELD

The present invention relates to materials technology, and particularly relates to a high-temperature resistant lightweight thermal insulation material with a dual-pore structure for high temperature equipment and a preparation method thereof. The present invention specifically provides a preparation technology of a high-temperature resistant lightweight thermal insulation material with a dual-pore structure comprising macroscopic through-pores and micro-pores that can be used in a high temperature environment up to 1800° C., where the volume ratio of the macroscopic through-pores to the micro-pores is controlled within an appropriate range to ensure that the dual-pore structure fully exerts synergistic effects.

### BACKGROUND

Refractory materials, which can be widely found in high-temperature equipment such as industrial furnaces, reactors, etc., are often used as basic structural components for high temperature equipment in the form of standard bricks or prefabricated parts. According to the working temperature and function thereof, the refractory materials may be generally divided into dense heavy refractory materials, hollow sphere refractory materials, porous lightweight thermal insulation materials, and fiber-based thermal insulation materials.

The heavy refractory materials are generally used in the high temperature equipment at places with the highest temperature, and include high-alumina heavy bricks, corundum mullite heavy bricks, etc. The heavy refractory materials have higher refractoriness and high-temperature strength than other types of refractory materials. However, due to compact structure and large volume, their volumetric heat capacity and thermal conductivity are too high, resulting in large heat storage and dissipation loss. On the other hand, the heavy refractory materials have large volumetric weight and thus are prone to creep due to their own weight at high temperatures, resulting in collapse or fracture of the furnace roof and deformation of the furnace wall. In order to reduce the amount of creep, the roof and the inner walls of the furnace are often thickened, which further leads to an increase in the heat storage capacity of the furnace, a decrease in the heat insulation effect, and an increase in energy consumption of the equipment. In addition to the creep, the dense refractory materials have poor thermal shock resistance (i.e., resistance to cold and heat shock) and thus have a short service life when used in intermittent high temperature equipment and when used as high temperature kiln furniture.

The hollow sphere refractory materials (such as alumina, zirconia hollow sphere refractory bricks, etc.), like heavy refractory materials, can be applied to the parts suffering the highest temperature, such as the lining of the furnace. Since the hollow sphere refractory materials contain a large number of hollow ceramic balls, their volumetric weight, volumetric heat capacity and thermal conductivity are all reduced, thus improving the energy-saving effect. However, their high-temperature creep resistance and thermal shock resistance are still poor, resulting in a short service life. Moreover, since a large number of hollow ceramic balls are contained, the molding difficulty is increased, the shape and size of the products are limited, and it is difficult to produce products of thin plate type.

For the lightweight thermal insulation materials, a pore-forming agent or a foaming process is adopted to generate a large amount of micro-pores (pore size ≤100 μm) in the material, thereby achieving the purpose of lowering the thermal conductivity and the like. The lightweight thermal insulation materials include, for example, lightweight clay bricks, mullite lightweight bricks, high alumina lightweight bricks, etc. Such materials have lower volumetric weight, volumetric heat capacity and thermal conductivity than the heavy refractory materials and hollow sphere refractory materials and thus have better energy-saving effect. Moreover, the large number of pores contained in such materials can restrict the development of cracks, thus providing better thermal shock resistance. However, the large number of micro-pores in the lightweight thermal insulation materials greatly reduces the contact surface between the grains inside the materials. Generally, when the microporosity is higher than about 30%, the strength and high-temperature creep resistance of the materials will drop sharply. Therefore, the high-porosity lightweight thermal insulation materials have significantly lower strength and high-temperature creep resistance than the dense materials with the same material and are usually used at a temperature lower than 1600° C. As a result, when used in a furnace operating at temperature higher than 1500° C., they cannot be used in the hottest parts such as the inner wall of the furnace.

The fiber-based thermal insulation materials refer to felt, board, block, or the like made of inorganic fibers, such as aluminum silicate, mullite, alumina fiber felt, board, and the like. Due to the large number of micropores present between the fibers, the fiber-based thermal insulation materials exhibit excellent thermal insulation performance, low volumetric weight, small volumetric heat capacity, low heat storage and dissipation loss, and excellent thermal shock resistance. However, the fiber-based heat insulation materials have extremely low strength and low refractoriness, and are generally used at a temperature lower than 1500° C. The fiber-based heat insulation materials resistant to higher temperatures are extremely expensive and cannot be widely used. Moreover, the fiber-based heat insulation materials are prone to pulverization and a short service life when working at high temperatures for a long time, and the dust formed by the pulverization is harmful to the human body and the environment.

In summary, the pore structure of refractory materials has an important influence on their high temperature performance and energy-saving effect. The dense refractory materials have good strength and high temperature creep resistance, but large volumetric heat capacity, high thermal conductivity, and poor energy-saving effect and thermal shock resistance. The porous refractory materials have good energy-saving effect and thermal shock resistance, but low strength and high temperature creep resistance. How to solve the contradiction between high temperature performance and energy-saving effect of the materials by designing the material composition and structure becomes the key to the development of high temperature energy-saving materials.

### SUMMARY OF THE INVENTION

The object of the present invention is to provide a high-temperature resistant lightweight thermal insulation material with a dual-pore structure comprising macroscopic through-pores and micro-pores that can be used in a high temperature environment up to 1800° C., where the volume ratio of the macroscopic through-pores to the micro-pores is controlled within an appropriate range to ensure that the dual-pore structure fully exerts synergistic effects. The present invention can be widely used for the production of various standard thermal insulation bricks, furnace roofing and sidewalls and the like, as well as various types of special-shaped thermal insulation structural parts and kiln furniture products.

The object of the present invention is achieved by the following:

A high-temperature resistant lightweight thermal insulation material having a dual-pore structure for high temperature equipment is prepared by adding a molding promoter and a pore former into raw materials including alumina (Al₂O₃), silica (SiO₂) and aluminosilicate powders, stirring the resulting mixture evenly and extrusion molding the same (for example, using a mould), followed by sintering, whereby the high-temperature resistant lightweight thermal insulation material having a dual-pore structure comprising macroscopic through-pores and micro-pores is obtained, wherein the volume ratio of the macroscopic through-pores to the micro-pores (namely, ratio of the total volume of the through-pores to the total volume of the micro-pores) is 0.5 to 25:1, preferably 1 to 15:1, and the total volume fraction of the through-pores and the micro-pores (namely, the sum of the volume fraction of the through-pores and the microporosity) is 18% to 80%. The macroscopic through-pores are parallel to each other, and the direction of the through-pores is perpendicular to the direction of heat flow in use. The extrusion molding may be carried out at a pressure of 100 to 150 MPa. The powders were passed through a 200-mesh sieve, with a maximum particle size of equal to or smaller than 75 μm.

The raw materials may be various crystalline or amorphous natural mineral powders or chemical synthetic raw material powders of alumina, silica, aluminosilicate, wherein the aluminosilicate includes but is not limited to mullite, andalusite, kyanite, flint clay, sillimanite, coal gangue, Suzhou clay, kaolin.

The raw materials of the present invention are preferably alumina, silica, electric melting mullite, andalusite, kyanite and Suzhou clay powders. The mass ratio of alumina, silica, electric melting mullite, andalusite, kyanite, and Suzhou clay powders is preferably 30 to 80:0 to 20:0 to 60:0 to 30:0 to 50:0 to 10, and most preferably, 40 to 70:1 to 15:30 to 50:10 to 20:20 to 40:1 to 8. The purity of the respective raw materials is of industrial grade, and the raw material powders were passed through a 200-mesh sieve, with a maximum particle size of equal to or smaller than 75 μm.

The molding promoter is one or more selected from polyvinyl alcohol (preferably a solution thereof having a concentration of 10%), polyvinyl butyral, polyethylene, polyvinyl chloride, methyl cellulose, hydroxypropyl methyl cellulose, glycerin, water, ethylene glycol, and stearic acid. Preferably, the molding promoter is a mixture of a polyvinyl alcohol solution, hydroxypropyl methyl cellulose, glycerin and water, and the mass ratio of the raw materials to the molding promoter is 100:20 to 100. Preferably, the mass ratio of the raw materials to the polyvinyl alcohol solution, hydroxypropyl methyl cellulose, glycerin and water is 100:5 to 20:5 to 20:10 to 50:0 to 10. The pore former is one or more selected from graphite, activated carbon, wood chips, starch, carbonate particles, hydroxide particles, and polystyrene beads, preferably the pore former is activated carbon, and the mass ratio of the raw materials to the pore former is 100:0.5 to 5. The purpose of using the molding promoter in the present invention is to make the raw material powders into a pug having plasticity. An appropriate amount of pore former can form micro-pores in the final product.

The specific sintering system includes an increase from the room temperature to 500° C. at a temperature increase rate of 0.5 to 2° C./min, an increase from 500° C. to 1000° C. at a temperature increase rate of 2 to 4° C./min, an increase from 1000° C. to 1300 to 1800° C. at a temperature increase rate of 0.5 to 2° C./min, a warm keeping for 0.5 to 5 hours, and finally a cooling down to the room temperature. Preferably, the sintering system includes an increase from the room temperature to 500° C. at a temperature increase rate of 0.5 to 2° C./min, an increase from 500° C. to 1000° C. at a temperature increase rate of 2 to 4° C./min, an increase from 1000° C. to 1500 to 1800° C. at a temperature increase rate of 0.5 to 2° C./min, a warm keeping for 0.5 to 5 hours, and finally a cooling down to the room temperature. This sintering system ensures the strength, porosity and crystal structure of the materials.

The macroscopic through-pores of the high-temperature resistant lightweight thermal insulation material according to the present invention have a density of 900 to 640,000 pores/m², preferably, 10,000 to 490,000 pores/m², a wall thickness of 0.2 to 20 nm, a volume fraction of through-pores (i.e., total volume of the through-pores/total volume of the thermal insulation materials) of 15% to 70%, preferably, 30% to 50%, and a shape of through-pores including but not limited to a square, a circle, a hexagon, and a triangle. The micropores are evenly distributed throughout the thermal insulation material, with an average pore size of 0.05 to 100 μm, and a microporosity (total volume of the micro-pores/total volume of the thermal insulation material) of 3% to 35%. The total mass of aluminum element (Al) and silicon element (Si) in the raw materials is equal to or larger than 40%, and the mass ratio of aluminum element to silicon element (Al/Si) is 2.8 to 10.2:1.

A method for preparing the above described high-temperature resistant lightweight thermal insulation material comprises the steps of: adding a molding promoter and a pore former into raw materials including alumina, silica and aluminosilicate powders, stirring the resulting mixture evenly and extrusion molding the same, followed by sintering, whereby the high-temperature resistant lightweight thermal insulation material having a dual-pore structure comprising macroscopic through-pores and micro-pores is obtained, wherein the ratio of the total volume of the through-pores to the total volume of the micro-pores is 0.5 to 25:1.

Preferably, the method for preparing the above described high-temperature resistant lightweight thermal insulation material comprises the steps of: adding alumina balls or zirconia balls to raw materials including alumina, silica, electric melting mullite, andalusite, kyanite, Suzhou clay powders, with water being a medium; subjecting the resulting mixture to ball-milling for 8 to 24 hours, wherein the mass ratio of the raw material powders, water, and balls is 1:1 to 2:1 to 2; after the milled slurry is dried, crushing and sieving the dried slurry, stirring powder resulting from sieving with activated carbon, polyvinyl alcohol solution (concentration: 10%), hydroxypropyl methylcellulose, glycerin, and water evenly in a kneader for 3 to 12 hours; subjecting the evenly stirred pug to vacuum pugging, followed by aging for 0 to 7 days, and extrusion molding in an extruder to obtain a Green body having a through-pore structure; and drying the Green body and sintering the same, wherein the sintering includes an increase from the room temperature to 500° C. at a temperature increase rate of 0.5 to 2° C./min, an increase from 500° C. to 1000° C. at a temperature increase rate of 2 to 4° C./min, an increase from 1000° C. to 1500 to 1800° C. at a temperature increase rate of 0.5 to 2° C./min, a warm keeping for 0.5 to 5 hours, and finally a cooling down to the room temperature.

Compared with the prior art, the present invention has advantages explained below:

(1) Since the wall thickness of the macroscopic through-pores is much larger than the size of the micro-pores, the macroscopic through-pores have a small influence on the contact surface between the microscopic grains, and a much smaller influence on the refractoriness, strength and creep resistance of the material than the micro-pores. The support structure formed by the through-pores ensures high strength and high-temperature creep resistance of the material; the macroscopic through-pore structure perpendicular to the heat flow direction suppresses thermal conduction and convection, greatly reduces the thermal conductivity of the material in the direction of heat flow, and significantly reduces the volumetric weight and volumetric heat capacity of the material. Through the synergistic effect of the appropriate volume of the micro-pore structure and the macroscopic through-pores, it breaks through the performance limitations of existing materials, improving the energy-saving effect and thermal shock resistance while ensuring the high-temperature performance of the materials.

(2) The mass ratio of aluminum element to silicon element (Al/Si) in the present invention is 2.8 to 10.2:1, which ensures sufficient formation of mullite phase and avoids excessive harmful phase. The excessive silicon element will remain in the form of free quartz and change in volume when temperature changes, resulting in a decrease in thermal shock resistance of the material. The appropriate amount of alumina helps to improve the refractoriness of the material, but excessive alumina residue can result in a significant reduction in thermal shock resistance and high temperature creep resistance of the material.

(3) Compared with the alumina hollow sphere thermal insulation material, the high-temperature resistant lightweight thermal insulation material according to the present invention has a volumetric weight of only 35% to 50%, a thermal conductivity of about 35%, and a volumetric heat capacity of about 30% to 40%, of those of the alumina hollow sphere thermal insulation material.

(4) Compared with the lightweight thermal insulation material, the macroscopic through-pore structure of the present invention further reduces the thermal conductivity of the material under the same microporosity, and significantly improves the strength and high temperature creep resistance of the material.

(5) Compared with alumina-based fiber-based thermal insulation material, the working temperature of the high-temperature resistant lightweight thermal insulation material of the present invention is increased by 200-300° C., up to 1800° C. Moreover, the high-temperature resistant lightweight thermal insulation material of the present invention has a much longer service life than the fiber-based thermal insulation materials and will not produce dust that is harmful to the human body and the environment.

(6) The high-temperature resistant lightweight thermal insulation material of the present invention can be widely used for producing products of various shapes and sizes, such as heat-insulating bricks, kiln roof and sidewalls and the like through the design of the extrusion die. Various types of special-shaped thermal insulation structural parts and kiln furniture products can be produced quickly and easily by processing the bulk products.

### BRIEF DESCRIPTION OF THE DRAWINGS

FIG. 1 shows the direction of heat flow perpendicular to the direction of the through-pores when measuring the thermal conductivity of the sample.

FIG. 2 shows the direction of heat flow parallel to the direction of the through-pores when measuring the thermal conductivity of the sample.

FIG. 3 shows a standard brick sample.

FIG. 4 is a plate sample.

### DESCRIPTION OF PREFERRED EMBODIMENTS

The present invention is further illustrated by the following examples and comparative examples. The specific details of the embodiments are only for explaining the present invention and should not be construed as limiting the general technical solutions of the present invention.

The materials used in the following examples and comparative examples were prepared using a method comprising the steps of: mixing the raw material powders with water and milling balls at a mass ratio of 1:2:1.5, and subjecting the resulting mixture to ball-milling for 24 hours; subjecting the milled slurry to drying, crushing and sieving to obtain an evenly mixed raw material powder and stirring the obtained powder with activated carbon, polyvinyl alcohol solution (concentration: 10%), hydroxypropyl methylcellulose, glycerin, and water evenly in a kneader for 12 hours, wherein the mass ratio of the raw material powder, polyvinyl alcohol solution, hydroxypropyl methylcellulose, glycerin, and water is 100:10:10:10:10; subjecting the evenly stirred pug to vacuum pugging, followed by aging for 1 day, and extrusion molding in an extruder under a pressure of 100 to 150 MPa to obtain a Green body having a through-pore structure; and drying the Green body and sintering the same, wherein the sintering includes an increase from the room temperature to 500° C. at a temperature increase rate of 0.5 to 2° C./min, an increase from 500° C. to 1000° C. at a temperature increase rate of 2 to 4° C./min, an increase from 1000° C. to 1700° C. at a temperature increase rate of 0.5 to 2° C./min, a warm keeping for 4 hours, and finally a cooling down to the room temperature.

Tables 1 and 2 respectively list the main performance indexes of the products prepared in the respective examples and comparative examples.

TABLE 1
Performance comparison of products of respective examples

| | | Example 1 | Example 2 | Example 3 | Example 4 | Example 5 | Example 6 |
|---|---|---|---|---|---|---|---|
| Al/Si (mass ratio) | | 6.0 | 4.2 | 6.8 | 2.8 | 5.3 | |
| Through-pore density | | 25 (wall thickness: 0.5mm) | | | | 49 (wall | 4 (wall |
| (10000 pores/m²) | | | | | | thickness: 0.4mm) | thickness: 1mm) |
| Through-pore volume | | 36.0 | | | | 46.2 | 25.0 |
| fraction (%) | | | | | | | |
| Microporosity (%) | | 11.5 | 16.0 | 9.6 | 17.9 | 11.8 | 16.5 |
| Total porosity (%) | | 47.5 | 52.0 | 45.6 | 53.9 | 58.0 | 41.5 |
| Total volume of | | 3.1 | 2.3 | 3.8 | 2.0 | 3.9 | 1.5 |
| through-pores / total | | | | | | | |
| volume of micro-pores | | | | | | | |
| Volumetric weight [symbol] | | 1.10 | 0.95 | 1.14 | 0.87 | 0.86 | 1.19 |
| Flexural strength at room | | 12.0 | 9.8 | 15.2 | 7.4 | 13.7 | 9.1 |
| temperature (MPa) | | | | | | | |
| Thermal | Perpendicular | 0.85 | 0.78 | 0.88 | 0.75 | 0.65 | 1.01 |
| conductivity | to through- | | | | | | |
| (W/m·K) | pores [symbol] | | | | | | |
| | Parallel to | 2.00 | 1.88 | 2.05 | 1.83 | 1.90 | 1.96 |
| | through-pores [symbol] | | | | | | |

| | | | | | | |
|---|---|---|---|---|---|---|
| Volumetric heat | 59 | 52 | 61 | 47 | 46 | 65 |
| capacity (J/K·m³) [symbol] | | | | | | |
| Creep index [symbol] | 1.65 | 2.64 | 1.98 | 2.91 | 1.74 | 2.54 |
| Thermal shock | 65 | 70 | 60 | 80 | 70 | 70 |
| resistance index [symbol] | | | | | | |

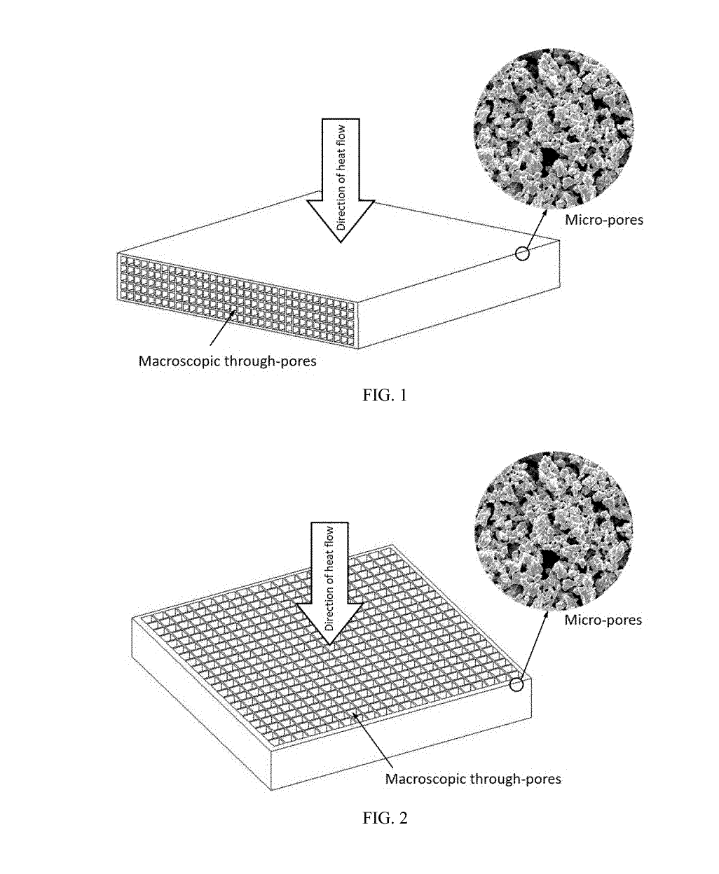

Note: [symbol]
Volumetric weight: Refers to the mass of refractory material per unit volume. The refractory material in this volume contains both solid materials, as well as micro-pores and macroscopic through-pores. [symbol]
Reference is made to FIG.1. [symbol]
Reference is made to FIG. 2. [symbol]
Volumetric heat capacity: Refers to the heat capacity value of refractory material per unit volume. [symbol]
The high temperature creep resistance of the sample is expressed by the creep index η. The test method was as follows: a long strip sample with dimensions of 16 mm × 12 mm × 200 mm (width × thickness × length) was prepared and placed on two points spaced from each other by a distance of 160 mm; a load of 0.2 MPa was applied at a midpoint of the sample's length by hanging a weight or by pressing the sample's head; the sample was heated to 1600°C. and held for 2 hours, and then naturally cooled to measure the amount of deformation $of the sample . The creep index is defined as η = ( tan α ) \times 100 = \frac{W}{L / 2} \times 100 ,$ where a is the angle by which the geometric center point of the upper surface of the sample is rotated relative to the position before deformation, W is the deflection, and L is the distance between the two endpoints of the sample after deformation. The smaller the creep index, that is, the smaller the amount of creep, the better the sample's resistance to high temperature creep. (Yan Jie, Chen Han, Dai Haijun, Guo Lucun. Effect of oxide impurities on mechanical properties and creep resistance of Al₂O₃ ceramics. BullChinCeramSoc, 34(1), 2015: 67—73) [symbol]
The thermal shock resistance of the sample is expressed as thermal shock resistance index F, which is defined as Γ = (σ̅ᵣ / σₒ) × 100, where σ̅ᵣ = (σ₅ + σ₁₀ + σ₂₀ + σ₃₀) / 4 is the average value of the flexural strength of the sample after 5, 10, 20, and 30 thermal shocks, σₒ is the flexural strength value of the sample without thermal shock. The greater the thermal shock resistance index, the better the thermal shock resistance of the sample. The thermal shock resistance test of the sample was as follows: the sample was held in an electric furnace at 600°C. for 2 minutes, then rapidly immersed in flowing water for quenching (water temperature = room temperature) for 10 seconds, and then the sample was taken out and quickly placed in the electric furnace at 600°C. again. One cycle of thermal shock was complete once one cycle of quenching from high temperature to room temperature was complete. (Kai Li, Dalei Wang, Han Chen, Lucun Guo. Normalized evaluation of thermal shock resistance for ceramic materials. Journal of Advanced Ceramics, 3(3), 2014: 250—258).

TABLE 2
Performance comparison of products of respective comparative examples

| | | Comparative | Comparative | Comparative | Comparative |
|---|---|---|---|---|---|
| | | example 1 | example 2 | example 3 | example 4 |
| Al/Si (mass ratio) | | 4.2 | 4.2 | 16.7 | 2.3 |
| Through-pore density (10000 pores/m²) | | 25 (wall thickness: 0.5 mm) | | | |
| Through-pore volume fraction (%) | | 36.0 | | | |
| Microporosity (%) | | 2.6 | 36.5 | 5.1 | 6.4 |
| Total porosity (%) | | 38.6 | 72.5 | 41.1 | 42.4 |
| Total volume of through-pores/ | | 13.8 | 1.0 | 7.1 | 5.6 |
| total volume of micro-pores | | | | | |
| Volumetric weight | | 1.22 | 0.55 | 1.31 | 1.06 |
| Flexural strength at room temperature | | 18.0 | 4.4 | 13.2 | 7.5 |
| (MPa) | | | | | |
| Thermal conductivity | Perpendicular to | 1.00 | 0.45 | 1.55 | 0.72 |
| (W/m · K) | through-pores^{\textcircled{1}} | | | | |
| | Parallel to | 2.23 | 1.35 | 3.11 | 1.79 |
| | through-pores^{\textcircled{2}} | | | | |

| | | | | |
|---|---|---|---|---|
| Volumetric heat capacity (J/K · m³) | 66 | 30 | 71 | 57 |
| Creep index | 1.85 | 9.37 | 10.04 | 15.60 |
| Thermal shock resistance index | 30 | 85 | 20 | 30 |

Note:
^{\textcircled{1}}Reference is made to FIG. 1.
^{\textcircled{2}}Reference is made to FIG. 2.

### EXAMPLE 1

In this example, the mass ratio of alumina, silica, electric melting mullite, andalusite, and Suzhou clay powders (as raw material) was 54:2:30:10:4. The mass ratio of the raw materials to the activated carbon pore former was 100:1.5. The Al/Si ratio in the raw materials in this example was 6.0:1, and the performance of the sample is listed in Table 1. The sample has a volumetric weight of 1.10, a flexural strength of 12 MPa, a thermal conductivity of 0.85 W/m·K (perpendicular to the through-pores) and 2.00 W/m·K (parallel to the through-pores), a volumetric heat capacity of 59 kJ/K·m³, a creep index of 1.65, and a thermal shock resistance index of 65. In this example, a standard brick mold was used for extrusion molding, and a blank having a width×thickness=137 mm×78 mm was extruded and cut into a standard brick Green body having a length of 277 mm, and a standard brick sample having a length×width×thickness=230 mm×114 mm×65 mm was obtained after sintering, as shown in FIG. 3.

### EXAMPLE 2

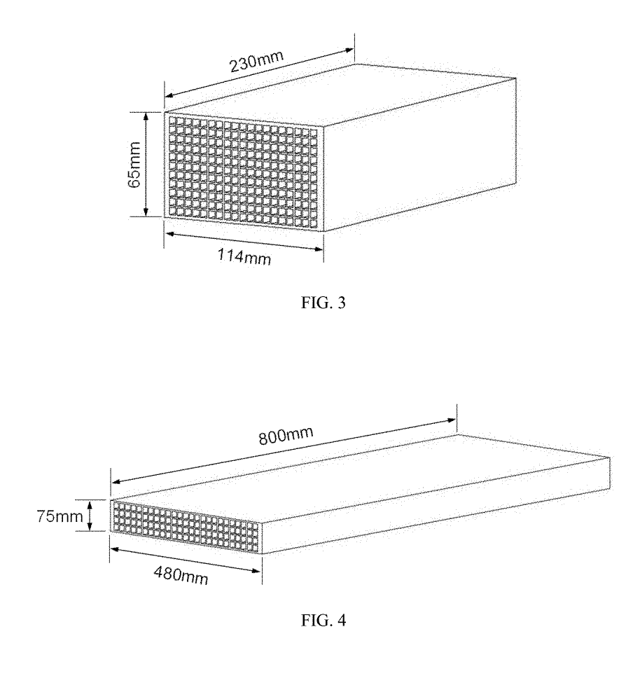

In this example, the mass ratio of alumina, silica, electric melting mullite, andalusite, and Suzhou clay (as raw material powders) was 42:2:30:20:6. The mass ratio of the total raw materials to the activated carbon pore former was 100:1.5. The Al/Si ratio in the raw materials in this example was 4.2:1, and the performance of the sample is listed in Table 1. The sample has a volumetric weight of 0.95, a flexural strength of 9.8 MPa, a thermal conductivity of 0.78 W/m·K (perpendicular to the through-pores) and 1.88 W/m·K (parallel to the through-pores), a volumetric heat capacity of 52 kJ/K·m³, a creep index of 2.64, and a thermal shock resistance index of 70. In this example, a flat mold was used for extrusion molding, and a blank having a width×thickness=578 mm×90 mm was extruded and cut into a flat Green body having a length of 963 mm, and a flat sample having a length×width×thickness=800 mm×480 mm×75 mm was obtained after sintering, as shown in FIG. 4.

### EXAMPLE 3

In this example, the mass ratio of including alumina, silica, electric melting mullite, kyanite, and Suzhou clay powders (as raw material powders) was 66:2:30:20:2. The mass ratio of the raw materials to the activated carbon pore former is 100:1.5. In this example, mullite and andalusite were replaced by kyanite as the main source of silica, and the amount of alumina used was more than that of Examples 1 and 2, the Al/Si ratio in the raw materials was 6.8:1. The performance of the sample is listed in Table 1.

### EXAMPLE 4

In this example, the mass ratio of alumina, silica, and electric melting mullite (as raw material powders) was 35:15:50. The mass ratio of the raw materials to the activated carbon pore former was 100:1.5. In this example, only three raw material powders were used, and the Al/Si ratio in the raw materials was 2.8:1. The performance of the sample is listed in Table 1.

### EXAMPLE 5

In this example, the mass ratio of alumina, silica, electric melting mullite, andalusite, and Suzhou clay (as raw material powders) was 50:2:30:15:3. The mass ratio of the raw materials to the activated carbon pore former was 100:1.5. The mass ratio of Al/Si in the raw materials in this example was 5.3:1. Due to the use of mold having a high through-pore density, the through-pore density of the sample in this example was larger than that of Examples 1 to 4, reaching 490,000 pores/m², and the volume fraction of the through-pores was 46.2%. The microporosity was 11.8%. The performance of the sample is listed in Table 1.

### EXAMPLE 6

In this example, the ratio of the respective raw materials and the amount of activated carbon pore former used were the same as in Example 5, so the Al/Si ratio was also the same. However, in this example, due to the use of a mold having a low through-pore density, the through-pore density of the sample was only 40,000 pores/m², and the volume fraction of the through-pores was 25.0%. The microporosity was 14.6%, and the performance of the sample is listed in Table 1.

### Comparative Example 1

In this example, the mass ratio of alumina, silica, electric melting mullite, andalusite, and Suzhou clay (as raw material powders) was 42:2:30:20:6. No pore former was added. The Al/Si ratio in the raw materials in this example was 4.2:1, but the microporosity was only 2.6%. The performance of the sample is listed in Table 2. Due to the too low microporosity, although the sample has a high flexural strength and good creep resistance, its volumetric weight, thermal conductivity and volumetric heat capacity are too large, resulting in an unsatisfactory high temperature energy-saving effect.

### Comparative Example 2

In this example, the ratio of the respective raw materials was the same as in Comparative Example 1, so the Al/Si ratio was also the same. The mass ratio of the raw materials to the activated carbon pore former was 100:6. The microporosity was 36.5%. The performance of the sample is listed in Table 2. Due to the too high microporosity, although the volumetric weight, thermal conductivity and volumetric heat capacity of the sample were ideal, the flexural strength was too low and the high temperature creep was large. As a result, the sample has no practical use value.

### Comparative Example 3

In this example, only two raw materials powders including alumina and andalusite were used, and the mass ratio of these two materials was 83:17. The mass ratio of the raw materials to the activated carbon pore former was 100:1.5. The mass ratio of Al/Si in the raw materials in this example was 16.7:1. The performance of the sample is listed in Table 2. The sample was poor in high temperature creep resistance and thermal shock resistance, thus cannot used at high temperatures.

### Comparative Example 4

In this example, the mass ratio of alumina, silica, electric melting mullite, andalusite, and Suzhou clay raw material powders was 15:10:50:20:5. The mass ratio of the raw materials to the activated carbon pore former was 100:1.5. The mass ratio of Al/Si in the raw materials in this example was 2.3:1. The performance of the sample is listed in Table 2. The sample was poor in high temperature creep resistance and thermal shock resistance, thus cannot used at high temperatures.

The purity of the respective raw materials used in the examples and comparative examples is of industrial grade, and the raw material powder was passed through a 200-mesh sieve, with a maximum particle size of equal to or smaller than 75 μm.

1. A high-temperature resistant lightweight thermal insulation material having a dual-pore structure, wherein the material is prepared by adding a molding promoter and a pore former into raw materials including alumina, silica and aluminosilicate powders, stirring the resulting mixture evenly and extrusion molding the same, followed by sintering, wherein the high-temperature resistant lightweight thermal insulation material having a dual-pore structure comprising macroscopic through-pores and micro-pores is obtained, wherein the ratio of the total volume of the through-pores to the total volume of the micro-pores is 0.5 to 25:1.

2. The high-temperature resistant lightweight thermal insulation material according to claim 1, wherein the ratio of the total volume of the through-pores to the total volume of the micro-pores is 1 to 15:1.

3. The high-temperature resistant lightweight thermal insulation material according to claim 1, wherein the total volume fraction of the through-pores and the micro-pores in the material is 18% to 80%.

4. The high-temperature resistant lightweight thermal insulation material according to claim 1, wherein the macroscopic through-pores are parallel to each other, and the direction of the through-pores is perpendicular to the direction of heat flow in use.

5. The high-temperature resistant lightweight thermal insulation material according to claim 1, wherein the macroscopic through-pores have a density of 900 to 640,000 pores/m², a wall thickness of 0.2 to 20 mm, and a volume fraction of 15% to 70%.

6. The high-temperature resistant lightweight thermal insulation material according to claim 5, wherein the macroscopic through-pores have a density of 10,000 to 490,000 pores/m².

7. The high-temperature resistant lightweight thermal insulation material according to claim 5, wherein the macroscopic through-pores have a volume fraction of 30% to 50%.

8. The high-temperature resistant lightweight thermal insulation material according to claim 1, wherein the total mass of aluminum element and silicon element in the raw materials is equal to or larger than 40%, and the mass ratio of aluminum element to silicon element is 2.8 to 10.2:1.

9. The high-temperature resistant lightweight thermal insulation material according to claim 1, wherein the macroscopic through-pores have a shape selected from the group consisting of a square, a circle, a hexagon, a triangle, and combinations thereof.

10. The high-temperature resistant lightweight thermal insulation material according to claim 1, wherein the micropores are evenly distributed throughout the thermal insulation material, with an average pore size of 0.05 to 100 μm, and a microporosity of 3% to 35%.

11. The high-temperature resistant lightweight thermal insulation material according to claim 1, wherein the raw materials may be various crystalline or amorphous natural mineral powders or chemical synthetic raw material powders of alumina, silica, aluminosilicate, wherein the aluminosilicate includes but is not limited to mullite, andalusite, kyanite, flint clay, sillimanite, coal gangue, Suzhou clay, kaolin.

12. The high-temperature resistant lightweight thermal insulation material according to claim 1, wherein the molding promoter includes one or more selected from polyvinyl alcohol, polyvinyl butyral, polyethylene, polyvinyl chloride, methyl cellulose, hydroxypropyl methyl cellulose, glycerin, water, ethylene glycol, and stearic acid, the mass ratio of the raw materials to the molding promoter is 100:20 to 100:100.

13. The high-temperature resistant lightweight thermal insulation material according to claim 1, wherein the pore former is selected from the group consisting of graphite, activated carbon, wood chips, starch, carbonate particles, hydroxide particles, polystyrene beads, and combinations thereof and the mass ratio of the raw materials to the pore former is 100:0.5 to 100:5.

14. The high-temperature resistant lightweight thermal insulation material according to claim 1, wherein the sintering system comprises an increase from room temperature to 500° C. at a temperature increase rate of 0.5 to 2° C./min, an increase from 500° C. to 1000° C. at a temperature increase rate of 2 to 4° C./min, an increase from 1000° C. to 1300 to 1850° C., a warm keeping for 0.5 to 5 hours, and finally a cooling down to the room temperature.

15. A method for preparing the high-temperature resistant lightweight thermal insulation material according to claim 1, comprising: adding a molding promoter and a pore former into raw materials including alumina, silica and aluminosilicate powders, stirring the resulting mixture evenly and extrusion molding the same, followed by sintering, wherein the high-temperature resistant lightweight thermal insulation material having a dual-pore structure comprising macroscopic through-pores and micro-pores is obtained, wherein the ratio of the total volume of the through-pores to the total volume of the micro-pores is 0.5 to 25:1.
